(19) United States
(12) Patent Application Publication
(10) Pub. No.: US 2024/0039062 A1
(43) Pub. Date: Feb. 1, 2024

(54) Removable Battery Pack with at least one Switching Element for Interrupting or Enabling a Charging or Discharging Current

(71) Applicant: Robert Bosch GmbH, Stuttgart (DE)

(72) Inventor: Holger Wernerus, Pliezhausen (DE)

(21) Appl. No.: 18/258,305

(22) PCT Filed: Dec. 13, 2021
(86) PCT No.: PCT/EP2021/085414

§ 371 Date: Jun. 19, 2023

(30) Foreign Application Priority Data
Dec. 21, 2020 (DE) 10 2020 216 370.7
Jan. 21, 2021 (DE) 10 2021 200 537.3

(51) Int. Cl. H01M 10/42; H01M 10/44; H02J 7/00

(52) U.S. Cl. CPC H01M 10/4264; H01M 10/441; H02J 7/007182

(57) ABSTRACT

A battery pack includes a monitoring device, at least one first switching element, an interface having a plurality of electrical contacts, and a measurement circuit. The monitoring device is configured to actuate the at least one first switching element, such that a charge or discharge current is interrupted or enabled via at least two of the electrical contacts of the plurality of electrical contacts. The measurement circuit is configured to convert a voltage value of a monitoring voltage into a measurement value of a measurement voltage in order to actuate the at least one first switching element. The monitoring device is configured to compare the measurement value with at least one first limit value and, when the limit value is exceeded or undershot, the monitoring device is configured to open the at least one first switching element.

### PRIOR ART

The invention relates to a battery pack, in particular an exchangeable battery pack with a monitoring device and with at least one first switching element for interrupting or enabling a charge or discharge current.

DE 103 54 871 A1 discloses an exchangeable battery pack that is equipped with a switching element in the current path for interrupting or enabling a charge or discharge current, which is controlled by a monitoring device of the exchangeable battery pack.

Starting from the prior art, it is the object of the invention to avoid high quiescent currents and to ensure reliable switching of the switching element for interrupting or enabling a charge or discharge current based on an existing exchangeable battery pack voltage.

### DISCLOSURE OF THE INVENTION

This is achieved by a battery pack with a monitoring device, at least one first switching element, in particular a MOSFET, and an interface comprising a plurality of electrical contacts, wherein the monitoring device can actuate the at least one first switching element such that a charge or discharge current is interrupted or enabled via at least two of the electrical contacts, wherein the battery pack comprises a measurement circuit, which converts a voltage value of a monitoring voltage into a measurement value of a measurement voltage to actuate the at least one first switching element, wherein the monitoring device compares the measurement value with at least one first limit value and, if the limit value is exceeded or undershot, opens the at least one first switching element. When this limit value is exceeded or undershot, the at least one first switching element is opened to interrupt a load current, thereby relaxing a battery voltage to its open-circuit potential. This prevents a further transient decrease of the voltage to be monitored, which could otherwise result in unfavorable subsequent effects. The measurement value of the measurement voltage may be configured as a magnitude of the measurement voltage or as a magnitude of a current signal.

The battery pack may include a first power supply contact, which can be biased by a first reference potential, preferably a supply potential, and a second power supply contact, which can be biased by a second reference potential, preferably a ground potential, wherein the at least one first switching element, in particular the MOSFET, is arranged to interrupt or enable the charge or discharge current via the first power supply contact and the second power supply contact, wherein the battery pack is configured to actuate the at least one first switching element by means of the monitoring voltage, wherein the monitoring voltage is derived from the first reference potential, in particular the supply potential, wherein the measuring tap is preferably connected between one, in particular the first, power supply contact and the at least one first switching element, and the monitoring voltage is present between the measuring tap and the ground potential. This prevents negative consequences of voltage dips due to high or load currents that vary greatly over time. The ground potential is preferably configured as a negative potential of a first battery cell of a battery cell string connected in series.

In one aspect, the monitoring voltage is directly derived from a drive voltage of the at least one first switching element. Monitoring this potential enables the most direct protection of the at least one first switching element.

In one aspect, the monitoring voltage is directly derived from the first reference potential, in particular from the supply potential, and is decoupled with respect to voltage fluctuations and dips of the first reference potential, in particular the supply potential. Monitoring this potential ensures that both the drive voltage of the switching element and the other supply voltage derived therefrom are protected from voltage dips. This is particularly advantageous because it also ensures, for example, that a control electronics of the at least one first switching element is protected from undervoltage.

In one aspect, the monitoring voltage is derived directly from the first reference potential, in particular from the supply potential. Monitoring this potential provides the fastest possible response to voltage dips.

The monitoring device may comprise a microprocessor configured to compare the measurement value with the limit value and to open the at least one first switching element if the limit value is exceeded or undershot. Preferably, the measurement value is configured as a measurement voltage, wherein the microprocessor is configured to obtain the magnitude of the measurement voltage. The microprocessor is preferably associated with the measurement device or the control device.

The monitoring device may comprise a comparator circuit configured to compare the measurement value with a reference voltage representing the limit value and to open the at least one first switching element if the limit value is exceeded or undershot. The comparator circuit is preferably associated with the measurement device. In addition, in this case, a microcontroller is provided. The monitoring device can comprise a measurement device with a transistor circuit comprising at least one transistor, which can be switched depending on the measurement value and whose switching threshold represents the limit value. Preferably, the control device is additionally configured to open the at least one first switching element if the limit value is exceeded or undershot.

It is further suggested that the battery pack comprises at least one resistor connected between a contact for the monitoring voltage and a ground potential, wherein the measurement voltage is present between the contact and the resistor.

The measurement circuit may comprise a first switching device which can be switched by a switching signal and a second switching device which can be switched by the first switching device, wherein the second switching device and at least two resistors are connected in series between the contact and the ground potential, and wherein a tap for the measurement voltage is connected between the two resistors and wherein the battery pack comprises a capacitor, which is connected between the first switching device and the tap for the measurement voltage.

The at least two resistors and the capacitor are preferably dimensioned such that the measurement voltage drops below the limit value leading to the interruption of the at least one switching element if a switching potential is too low for reliable operation of the at least one first switching element.

Preferably, a restart of the at least one first switching element is enabled by exceeding a limit value or the limit value again. In particular, the switching element is configured such that it can be switched on by the monitoring device, wherein the switching on preferably takes place via a microprocessor. As an alternative to the microprocessor, a discrete circuit would also be conceivable.

The control device is preferably configured to output the switching signal to the first switching device, in particular a transistor, preferably a MOSFET, for enabling the measurement of the measurement voltage when a charging process or a discharging process is active and otherwise not output a switching signal to the first switching device, in particular the transistor, preferably the MOSFET, for enabling the measurement of the measurement voltage.

Further advantageous embodiments result from the following description and the drawing. The drawing shows:

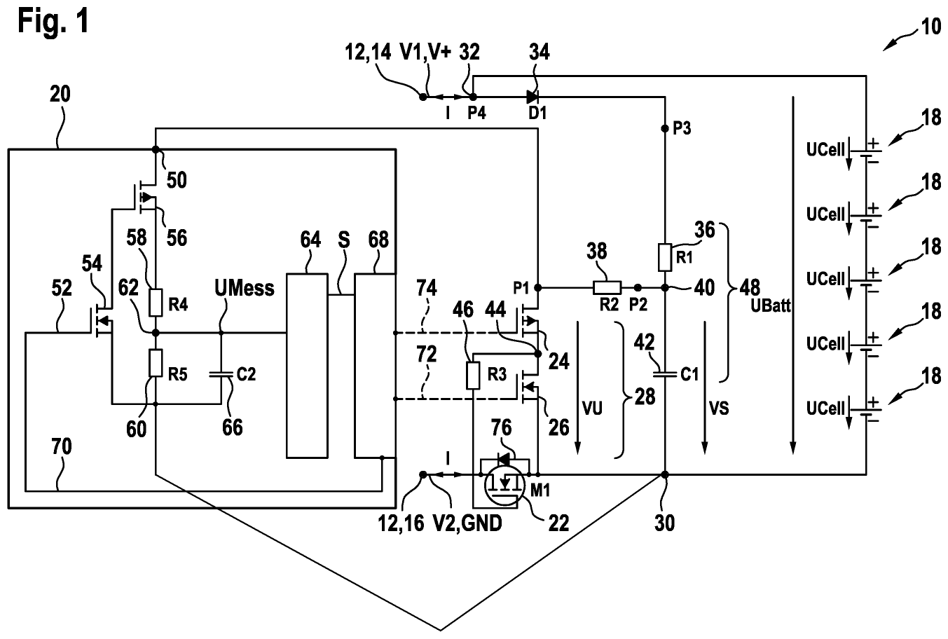

FIG. 1 a portion of a first embodiment of a battery pack,

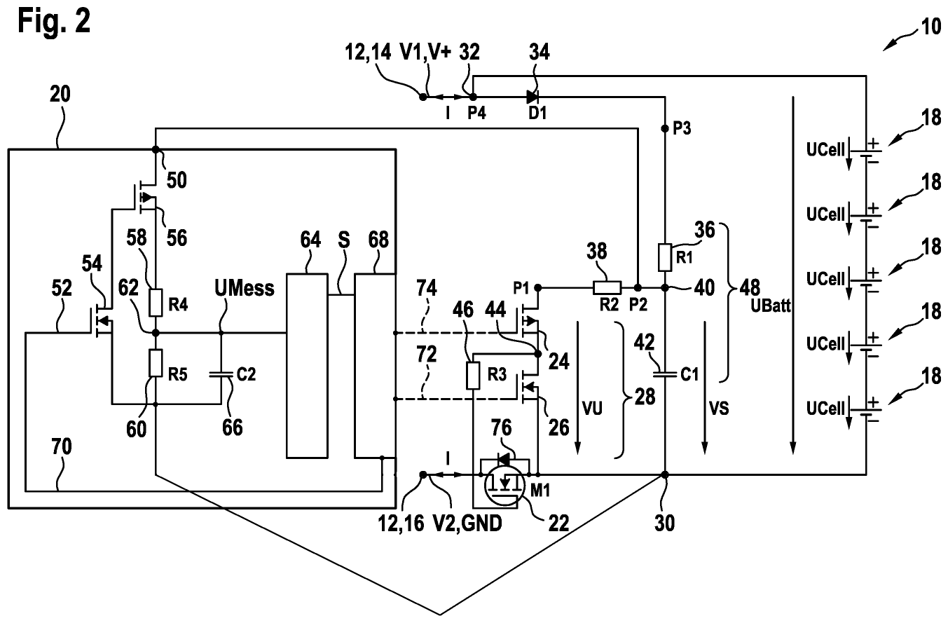

FIG. 2 a portion of a second embodiment of a battery pack,

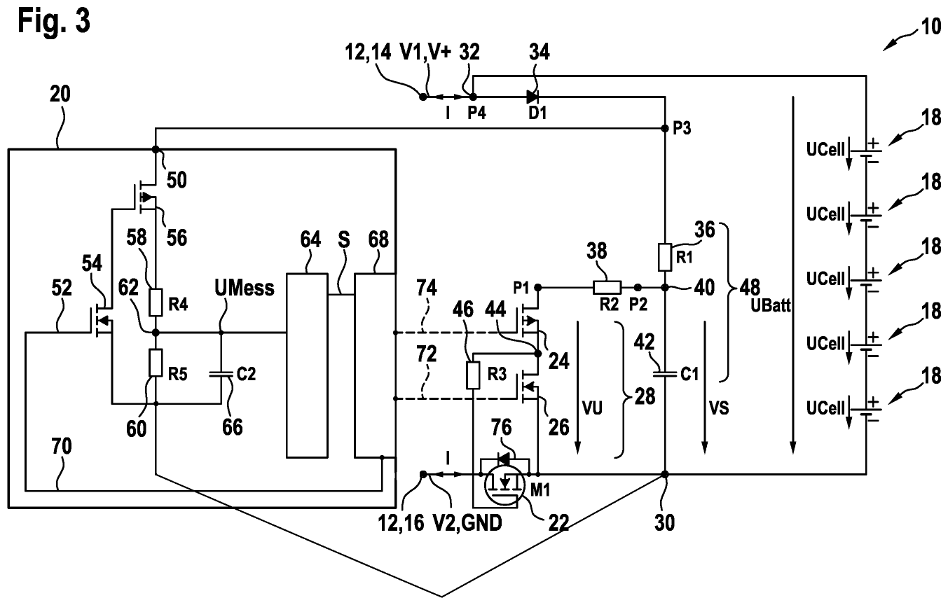

FIG. 3 a portion of a third embodiment of the battery pack,

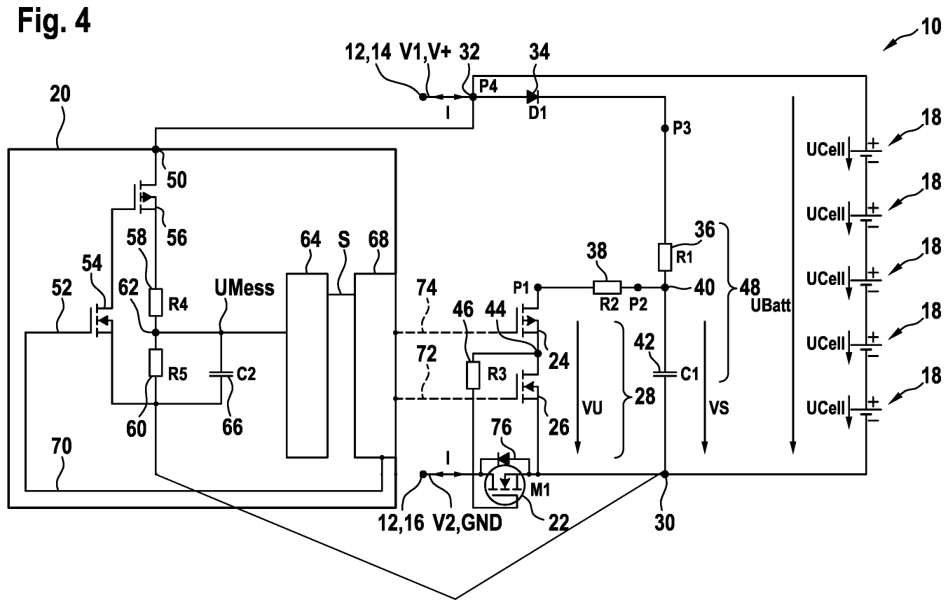

FIG. 4 a portion of a fourth embodiment of the battery pack,

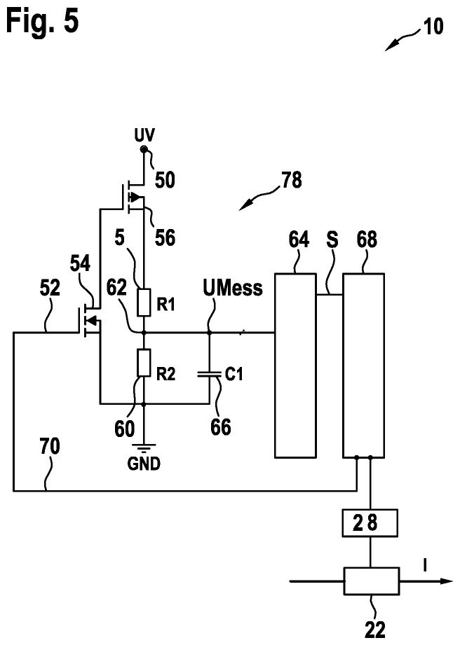

FIG. 5 a portion of a fifth embodiment of the battery pack.

FIG. 1 shows a block diagram depicting a portion of an exchangeable battery pack 10. The exchangeable battery pack 10 is releasably connected to a charger or electric consumer not shown in FIG. 1. The exchangeable battery pack 10 and the charger or the electric consumer respectively have corresponding electromechanical interfaces, of which a plurality of electrical contacts 12 of the exchangeable battery pack 10 are shown in FIG. 1.

A first of the electrical contacts 12 serves as a power supply contact 14 which can be biased with a first reference potential V1, preferably a supply potential V+. A second of the electrical contacts 12 serves as a power supply contact 16 which can be biased with a second reference potential V2, preferably a ground potential GND.

Via the first and second power supply contacts 14, 16, the exchangeable battery pack 10 can, on the one hand, be charged by a charger with a charge current and, on the other hand, be discharged by the electric consumer with a discharge current. The current strengths of the charge and the discharge current can differ significantly from one another. The discharge current in correspondingly designed electric consumers can for example be up to 10 times higher than the charge current of the charger. In the following, despite these differences between charge and discharge current, the common symbol I will be used. The phrase “can be biased” is intended to clarify that the potentials V+ and GND, in particular in the case of an electric consumer are not permanently present at the power supply contacts 14, 16 but are present only after the electromechanical interfaces have been connected.

The same applies to a discharged exchangeable battery pack 10 after connection to the charger.

The exchangeable battery pack 10 comprises a plurality of energy storage cells 18, which are shown in FIG. 1 as a series circuit but may alternatively or additionally also be operated in a parallel circuit, wherein the series circuit defines the voltage UBatt of the exchangeable battery pack 10 dropping across the power supply contacts 14, 16, while a parallel circuit of individual energy storage cells 18 primarily increases the capacity of the exchangeable battery pack 10. As mentioned, it is also possible for individual cell clusters, which comprise energy storage cells 18 connected in parallel, to be connected in series in order to achieve a specific voltage UBatt of the exchangeable battery pack 10 while at the same time increasing the capacity. For conventional Li-ion energy storage cells 18 with a cell voltage UCell of 3.6 V each, an exchangeable battery pack voltage UBatt=V1−V2 of 5·3.6 V=18 V drops across the power supply contacts 14, 16 in the present exemplary embodiment. Depending on the number of energy storage cells 18 connected in parallel in a cell cluster, the capacity of conventional exchangeable battery packs 10 can be up to 12 Ah or more. However, the invention is not dependent on the type, design, voltage, power supply capability, etc. of the energy storage cells 18 used, but can be used for any exchangeable battery pack 10 and energy storage cells 16. The invention can also be used for non-exchangeable battery packs.

A monitoring device 20 is provided for monitoring the exchangeable battery pack 10. In order to be able to interrupt or enable the charge or discharge current I within the exchangeable battery pack 10 in order to increase operational reliability, the exchangeable battery pack 10 comprises at least one first switching element 22, which can be opened by the monitoring device 20 via a half bridge 28 consisting of a second and a third switching element 24, 26 for interrupting the charge or discharge current I and closed to enable the charge or discharge current I. In the exemplary embodiment shown, the at least one first switching element 22 is arranged in a ground path (low side) between the second contact 12, configured as a power supply contact 16, of the electromechanical interface and a ground contact point 30 of the series connection of the energy storage cells 18. Alternatively or in addition, it is also possible to arrange at least one first switching element 22 in the high side path between a tap 32 for the series connection of the energy storage cells 18 and the first contact 12, configured as the power supply contact 14, of the electromechanical interface. Moreover, a plurality of first switching elements 22 can respectively be disposed in both the low side and the high side paths. Preferably, the at least one first switching element 22 is configured as a MOSFET, as shown in FIG. 1. However, other switching elements, for example a relay, an IGBT, a bipolar transistor, or the like, can also be used.

Analogously to the at least one first switching element 22, the two switching elements 24, 26 of the half bridge 28 are likewise preferably configured as MOSFETs, as shown in FIG. 1. However, other second and third switching elements 24, 26, such as relays, IGBTs, bipolar transistors or the like, are also conceivable. In the present exemplary embodiment, the second switching element 24, which is configured as a high side switch of the half bridge 28, is a P channel MOSFET and the third switching element 26, which is configured as a low side switch of the half bridge 28, is an N channel MOSFET. To interrupt the charge or discharge current I, the at least one first switching element 22 is now opened by the monitoring device 20 by closing the third switching element 26. The monitoring device 20 can moreover also open the second switching element 24, but this is not absolutely necessary. Conversely, the monitoring device 20 enables the charge or discharge current I by closing the at least one first switching element 22 by closing the second switching element 24 when the third switching element 26 is open. For this purpose, the half bridge 28 is connected to the reference potential GND on the one hand and to the supply potential V+ on the other hand via a protective diode 34 as well as a first resistor 36 and a second resistor 38, whereby a tap 40 between the first and the second resistor 36, 38 serves as the connection point for a capacitor 42, which is in turn connected to the second power supply contact 16 of the electromechanical interface. Thus, the capacitor 42, the second resistor 38 and the half bridge 28 are connected in parallel to the control potential of the at least one first switching element 22. Furthermore, a tap 44 between the two switching elements 24, 26 of the half bridge 28 is connected via a third resistor 46 to a control input of the at least one first switching element 22, in particular to a gate terminal of the MOSFET.

The first resistor 36 and the capacitor 42 themselves form an RC element 48, the time constant τ of which results from the product of the resistance value R1 of the first resistor 36 and the capacity C1 of the capacitor 40. Preferably, the time constant τ is dimensioned such that no charging times of the at least one capacitor 42 result, which are disadvantageously high for the exchangeable battery pack 10 and could negatively affect the switching on of the at least one first switching element 22. The risk of functional impairments or performance losses of the exchangeable battery pack 10 can be effectively reduced due to the resulting avoidance of switching times that are too long or switching potentials that build up too slowly before the at least one first switching element 22 is switched on.

The RC element 48 is decoupled from the supply potential V+ via the protective diode 34, which is preferably configured as a Schottky diode. Thus, the protective diode 34 protects the RC element 48 from a voltage dip between the supply potential V+ and the ground potential GND. The configuration of the protective diode 34 as a Schottky diode also offers the advantage of a lower voltage drop, so that a higher voltage is available for switching the at least one first switching element 22.

The tap 44 between the first and the second resistor 36, 38 simultaneously forms a center tap of the RC element 48 at which a decoupled switching potential VS for switching the at least one first switching element 22 via the half bridge 28 is present. The first resistor 36 of the RC element 48 is dimensioned such that its resistance value R1 does not produce any heat that is hazardous for the exchangeable battery pack 10 in the event of a short circuit. Such a short circuit may arise internally, for example, from a fault in the capacitor 42 of the RC element 28, from a fault in the monitoring device 20 or in the half bridge 28. To avoid overloading the first resistor 36 by a short circuit, its resistance value R1 is at least 1 kfl. However, since this would limit the switching current for the at least one first switching element 22, the capacitor 42 of the RC element 48 must have a sufficiently high capacitance C1. Ideally, the capacitance C1 is sized to be significantly larger than the sum of all capacitances of the exchangeable battery pack 10 that are charged when the at least one first switching element 22 is switched on. For example, a value of approximately 100 nF for the capacitance C1 would be conceivable. However, in order to ensure a switching potential VS, which only degrades slowly in the event of a short circuit, values of more than 1 μF for the capacitance C1 are advantageous. In addition, the high-impedance design of the RC element 48 provides an advantage in that the switching potential VS for the at least one first switching element 22 is largely decoupled from short circuits at or in the exchangeable battery pack 10.

The switching potential VS can now be applied by the monitoring device 20 via the half bridge 28 as well as the second and third resistor 38, 46 in the described manner to a control input of the at least one first switching element 22, for example to the gate terminal of the MOSFET, in order to close it. The second and the third resistor 38 and 46 are sized such that, due to their resulting resistance value R2+R3, the switching current required for a fast switching of the at least one first switching element 22 is not too low and, on the other hand, in the event of a short-circuit or if the second and third switching element 24, 26 of the half bridge 28 are accidentally switched on simultaneously, there is no heat generation that is hazardous for the exchangeable battery pack 10. Preferably, the resulting resistance value R2+R3 of the second and third resistors 38, 46 is significantly less than 1 kfl. In addition, optimized sizing of the second resistor 38 has the effect that the currents that may occur as a result of switching the second at least one first switching element 22, which is configured as a high side switch, do not result in excessive component stress, which could lead to premature aging, in particular of the second switching element 24 and the second resistor 38 and thus to damage to the exchangeable battery pack 10. Instead of the second and third resistors 38, 46, only a single resistor may be used. Multiple resistors are also conceivable. The same applies to the number of capacitors and resistors of the RC element.

The monitoring device 20 ensures reliable and fast switching of the at least one first switching element 22 for interrupting or enabling the charge or discharge current on the basis of an existing exchangeable battery pack voltage without any voltage fluctuations of the exchangeable battery pack voltage affecting the function of the at least one first switching element 22.

During operation of a tool that is powered by the exchangeable battery pack 10, the voltage UBatt, is subject to strong fluctuations due to, for example, resistances of conductor tracks, cell connectors and cells or their inductive components in combination with high load currents or load currents that vary greatly over time.

Both a function of the monitoring device 20 and reliable and fast switching are only available if a minimum supply voltage is ensured. Furthermore, it is problematic for many embodiments of the switching elements if their control voltage falls below a minimum threshold, since a sufficiently low impedance state of the switching element can then no longer be ensured and the power loss occurring in the switching element increases dramatically. For the exchangeable battery pack 10, its quiescent current consumption within its electronics is a critical quantity. In order to avoid self-discharging of the battery pack 10, it is advantageous to keep quiescent currents within the battery as low as possible.

The monitoring device 20 is configured to protect the at least one first switching element 22 from a too low control voltage. In the example, the MOSFET is protected from a too low control voltage.

For this purpose, the monitoring device 20 comprises a contact 50 for a monitoring voltage VU. The monitoring voltage VU is a possibly pre-filtered/processed potential that is directly dependent on the voltage UBatt of the exchangeable battery pack 10.

A switching signal 52 originating from monitoring device 20 activates a first switching device 54. This results in a second switching device 56 transitioning to a conductive state and the monitoring voltage VU being divided down via a fourth resistor 58 and a fifth resistor 60, i.e. at a tap 62 between these resistors 58, 60, acquired as a measurement voltage UMess and forwarded to a measurement device 64. The monitoring device 20 may comprise a capacitor 66 connected between the first switching device 54 and the ground potential.

The two switching devices 54, 56 are preferably configured as MOSFETs. However, other second and third switching elements 54, 56, such as relays, IGBTs, bipolar transistors or the like, are also conceivable. In the present exemplary embodiment, the second switching element 24, which is configured as a high side switch of the half bridge 28, is a P channel MOSFET and the third switching element 26, which is configured as a low side switch of the half bridge 28, is an N channel MOSFET.

If the monitoring voltage VU falls below a certain potential due to load jumps, for example, the measurement device 64 is triggered. Triggering the measurement device 64 causes a signal S to be forwarded to a control device 68.

For example, the first resistor 58, the second resistor 60 and the capacitor 66 are sized such that the measurement voltage UMess falls below a limit value if a switching potential VS that is too low for the reliable operation of the at least one first switching element 22 is present. For example, the measurement device 64 is configured to output the signal S if the limit value is undershot.

In the example, the switching signal 52 emanating from the monitoring device 20 is activated by the control device 68 via a signal line 70 when a measurement for monitoring the monitoring voltage VU is to be carried out, or otherwise deactivated. The example provides for the switching signal 52 to be activated during the charging process or the discharging process and otherwise to be deactivated. As a result, the exchangeable battery pack 10 does not discharge itself during storage due to permanently connected discharge paths.

The control device 68 is connected to the second switching element 24 via a first control line 72 and to the third switching element 26 via a second control line 74. The control device 68 is configured to actuate the second switching element 24 and the third switching element 26 to enable or interrupt the charge and/or discharge current I, i.e., to open the at least one switching element 22 or to close the at least one switching element 22.

In the example shown in FIG. 1, the signal S being passed on to control device 68 indirectly causes the at least one first switching element 22 to be switched off. For example, the control device 68 interrupts the charge or discharge current I by opening the at least one first switching element 22 by closing the third switching element 26.

The invention is not limited to indirect switching off. It may be provided that passing the signal S results in the at least one switching signal 22 being switched off directly, independent of the second switching element 24 and independent of the third switching element 26.

Thereby the charge or discharge current I is interrupted and the voltage UBatt relaxes to its open-circuit potential.

According to the invention, one or more circuits according to the present invention may be implemented in their different variants to monitor more than one monitoring voltage VU. For example, a control voltage of MOSFETs or a supply voltage of battery electronics may be monitored.

In FIG. 1, a first measuring tap P1, a second measuring tap P2, a third measuring tap P3 and a fourth measuring tap P4 are shown, at which potentials within the battery electronics that are particularly suitable as a monitoring voltage VU can be tapped in order to protect the at least one switching element 22, e.g. the MOSFET, from too low a control voltage.

The first measuring tap P1 provides a drive voltage of the at least one switching element 22. Monitoring this potential enables the most direct protection of the switching element 22.

The second and third measuring taps P2, P3 each provide a decoupled battery voltage. Monitoring this potential ensures that both the drive voltage of the at least one switching element 22 and other supply voltages derived therefrom are protected from voltage dips. This is particularly advantageous because it also ensures, for example, that the further control electronics, e.g., the control device 68, are protected from undervoltage.

With this protection, it is particularly advantageous to consider different undervoltage thresholds for different parts of the battery electronics at the second or the third measuring tap P2, P3. For example, a minimum input voltage of a voltage regulator of the battery electronics is 8V, while a minimum monitoring voltage for the half bridge 28 before impermissible power losses may occur in the at least one switching element 22 is 5V, for example.

Via a suitable parameterization of the described components, it is possible to protect the first or second measuring tap P2, P3 from a minimum voltage of e.g. 8V, and at the same time ensure that, for example, the gate source voltage of the MOSFETs does not fall below 5V.

The fourth measuring tap P4 provides the non-decoupled voltage UBatt. Monitoring this potential provides the fastest possible response to voltage dips.

In the example shown in FIG. 1, the monitoring voltage VU is acquired at the first measuring tap P1. The invention also includes acquisition at the other measuring taps. This is described in FIG. 2 for the second measuring tap P1, in FIG. 3 for the third measuring tap P3 and in FIG. 4 for the fourth measuring tap P4. Components that in these cases have the same function as the components described for the example with the first measuring tap P1 are designated with the same reference numeral.

The measurement device 64 and/or the control device 68 may be designed as an integrated circuit in the form of a microprocessor, ASIC, DSP, or the like. The monitoring device 20 may be designed in the form of a microprocessor, ASIC, DSP, or the like. However, it is also conceivable that the monitoring device 20 consists of a plurality of microprocessors or at least in part of discrete components with corresponding transistor logic. In addition, the first monitoring device 20 may comprise a memory for storing operating parameters of the exchangeable battery pack 10, such as the voltage UBatt, the cell voltages UCell, a temperature T, a charge or discharge current I, or the like.

FIG. 5 shows a block diagram depicting a portion of the exchangeable battery pack 10. The exchangeable battery pack 10 comprises the measurement device 64, the control device 68 and a measurement circuit 78 with which the measurement voltage UMess is derived directly from the monitoring voltage UV.

The measurement circuit 78 includes the contact 50, the first switching device 54 which can be activated by the switching signal 52, the second switching device 56 which can be activated by said first switching device, the fourth resistor 58, the fifth resistor 60, and the tap 62 between these resistors 58, 60, at which the measurement voltage UMess is acquired and passed to a measurement device 64. In the example, the monitoring device 20 comprises the capacitor 66, which is connected between the first switching device 54 and the tap 62.

The control device 68 may include a microprocessor configured to compare the measurement value with the limit value and to open the at least one first switching element 22 if the limit value is exceeded or undershot.

The control device 68 may comprise a comparator circuit configured to compare the measurement value with a reference voltage representing the limit value and to open the at least one first switching element 22 if the limit value is exceeded or undershot.

The control device 68 may comprise a transistor circuit comprising at least one transistor which can be switched depending on the measurement value and whose switching threshold represents the limit value. The switching of the transistor in this example causes the opening of the at least one first switching element 22.

The components described are part of a particularly advantageous design. However, it is also within the meaning of the invention when individual components are omitted or added. Additional measuring taps can be inserted by adding components. By omitting components, measuring taps can be reduced compared to what has been described.

Finally, it should be noted that the exemplary embodiments shown are not limited to either the type of exchangeable battery pack 10 shown in the figures, or to interaction with specific chargers or electric consumers. The same applies to the number of energy storage cells 18. In addition, the shown embodiments/interfaces, as well as the number of their contacts 12, are to be understood merely as examples.

1. A battery pack comprising:
a monitoring device;
at least one first switching element;
an interface including a plurality of electrical contacts; and
a measurement circuit,
wherein the monitoring device is configured to actuate the at least one first switching element, such that a charge or discharge current is interrupted or enabled via at least two electrical contacts of the plurality of electrical contacts,
wherein the a measurement circuit is configured to convert a voltage value of a monitoring voltage into a measurement value of a measurement voltage to actuate the at least one first switching element,
wherein the monitoring device is configured to compare the measurement value with at least a first limit value, and
wherein when the first limit value is exceeded or undershot by the measurement value, the monitoring device is configured to open the at least one first switching element.

2. The battery pack according to claim 1, further comprising:
a first power supply contact biased by a first reference potential; and
a second power supply contact biased by a second reference potential,
wherein the at least one first switching element is configured to interrupt or enable the charge or discharge current via the first power supply contact and the second power supply contact,
wherein the battery pack is configured to actuate the at least one first switching element via the monitoring voltage,
wherein the monitoring voltage is derived from the first reference potential,
wherein a measuring tap is connected between the first power supply contact and the at least one first switching element, and
wherein the monitoring voltage is present between the measuring tap and a ground potential.

3. The battery pack according to claim 2, wherein a drive voltage of the at least one first switching element is configured as the monitoring voltage.

4. The battery pack according to claim 2, wherein the monitoring voltage is derived directly from the first reference potential, and is decoupled with respect to voltage fluctuations and dips of the first reference potential.

5. The battery pack according to claim 2, wherein the first reference potential is configured as the monitoring voltage.

6. The battery pack according to claim 1, wherein the monitoring device comprises a microprocessor configured to compare the measurement value with the limit value and to open the at least one first switching element when if the limit value is exceeded or undershot.

7. The battery pack according to claim 1, wherein the monitoring device comprises a comparator circuit configured to compare the measurement value with a reference voltage representing the limit value and to open the at least one first switching element when the limit value is exceeded or undershot.

8. The battery pack according to claim 1, wherein:
the monitoring device comprises a measurement device with a transistor circuit,
the transistor circuit comprises at least one transistor configured to be switched depending on the measurement value, and
a switching threshold of the at least one transistor represents the limit value.

9. The battery pack according to claim 1, further comprising:
at least one resistor connected between a contact for the monitoring voltage and a ground potential, and
the measurement voltage is present between the contact and the resistor.

10. The battery pack according to claim 9, wherein:
the measurement circuit comprises a first switching device configured to be switched by a switching signal and a second switching device configured to be switched by the first switching device,
the second switching device and at least two resistors are connected in series between the contact and the ground potential,
a tap for the measurement voltage is connected between the at least two resistors, and
the battery pack comprises a capacitor connected between the tap for the measurement voltage and the ground potential.

11. The battery pack according to claim 10, wherein the at least two resistors and the capacitor are sized such that (i) the measurement voltage falls below the limit value which leads to an interruption of the at least one switching element when there is insufficient switching potential for reliable operation of the at least one first switching element and (ii) the measurement voltage exceeds the limit value which leads to switching on the at least one switching element when there is sufficient switching potential for reliable operation of the at least one first switching element.

12. The battery pack according to claim 10, wherein the control device is configured to output the switching signal to the first switching device for enabling the measurement of the measurement voltage when a charging process or a discharging process is active, and otherwise not output the switching signal to the first switching device, for enabling the measurement of the measurement voltage.
